(19) United States
(12) Patent Application Publication
(10) Pub. No.: US 2006/0016958 A1
(43) Pub. Date: Jan. 26, 2006

(54) Objective optical element and optical pickup apparatus

(75) Inventor: Kiyono Ikenaka, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc, Tokyo (JP)

(21) Appl. No.: 11/181,461

(22) Filed: Jul. 14, 2005

(30) Foreign Application Priority Data
Jul. 23, 2004 (JP) JP2004-216208
Sep. 16, 2004 (JP) JP2004-269684

(51) Int. Cl. H01J 3/14; G02B 7/04; G01V 8/00

(52) U.S. Cl. 250/201.5; 250/216

(57) ABSTRACT

An objective optical element for use in an optical pickup apparatus which conducts reproducing and/or recording information for first, second and third optical information recording mediums, comprises a first lens which is made of a material A having Abbe's number being within a range of 20 to 40 for d-line and comprises a first diffractive structure in which a cross-sectional form of each of concentric circle patterns is shaped in a stair form, and a second lens which is made of a material B having Abbe's number being within a range of 40 to 70 for d-line and comprises a second diffractive structure in which a cross-sectional form of each of a plural concentric ring-shaped zones is shaped in a saw tooth form.

This application is based on Japanese Patent Application No. JP2004-216208 filed on Jul. 23, 2004, and JP2004-269684 filed on Sep. 16, 2004, in Japanese Patent Office, the entire content of which is hereby incorporated by reference.

### BACKGROUND OF THE INVENTION

The present invention relates to an optical pickup element and an optical pickup apparatus.

In an optical pickup apparatus in recent years, there has been advanced a trend toward a shorter wavelength of a laser light source that is used as a light source for * reproducing of information recorded on an optical disc and for recording of information on an optical disc, and for example, laser light sources with wavelength 405 nm such as a violet semiconductor laser and a violet SHG laser wherein a wavelength of an infrared semiconductor laser is converted by using second harmonic generation are being put to practical use.

When using these violet laser light sources, it becomes possible to record information in an amount of 15-20 GB for an optical disc having a diameter of 12 cm in the case of using an objective lens having the same numerical aperture (NA) as in a digital versatile disc (hereinafter referred briefly to DVD), and it becomes possible to record information in an amount of 23-27 GB for an optical disc having a diameter of 12 cm when the NA of the objective lens is enhanced to 0.85. In the present specification, an optical disc using a violet laser and a magneto-optical disc are named generically as “a high density disc”.

Incidentally, there are proposed two standards presently as a high density disc. One of them is a Blue-ray disc (hereinafter referred briefly to BD) that uses an objective lens with NA of 0.85 and has a protective layer thickness of 0.1 mm, and the other is HD DVD (hereinafter referred briefly to HD) that uses an objective lens with NA of 0.65-0.67 and has a protective layer thickness of 0.6 mm. When considering a possibility that high density discs of these two standards will appear on the market in the future, a compatible optical pickup apparatus that can conduct recording and reproducing for all types of high density optical discs including DVD and CD is important.

In the case of an objective lens that is compatible for HD, DVD and CD, when tracking characteristics are taken into consideration, it is preferable to arrange so that light of any wavelength among all kinds of wavelengths enters the objective lens as infinite collimated light or as finite light that is close to the infinite collimated light.

However, it is necessary to correct chromatic spherical aberration caused by a difference of wavelengths of light fluxes to be used between HD and DVD, and it is necessary to correct spherical aberration caused by a difference of base board thicknesses (protective layer thicknesses) between HD and CD, in addition to the chromatic spherical aberration.

In particular, since spherical aberration caused by a difference between base board thicknesses of HD and CD, there have been known various technologies for correcting spherical aberration in an optical lens having compatibility among optical discs for three types of HD, DVD and CD and in an optical pickup apparatus (for example, see Patent Documents 1-3).

(Patent Documents 1) TOKKAI No. 2004-079146

(Patent Documents 2) TOKKAI No. 2002-298422

(Patent Documents 3) TOKKAI No. 2003-207714

In Example 7 for numerical values of Patent Document 1, there is disclosed an objective lens that corrects spherical aberration caused by a protective layer thickness between a high density optical disc and CD, by providing a diffractive structure that generates second order diffracted light in a violet laser light flux, and generates first order diffracted light in a red laser light flux and an infrared laser light flux on the surface of the objective lens, and by correcting spherical aberration caused by a protective layer thickness between a high density optical disc and DVD with an operation of the diffractive structure, and further by making a divergent light flux to enter the objective lens in the case of conducting recording and reproducing of information for CD.

In this objective lens, there is a problem that excellent characteristics for recording and reproducing cannot be obtained for CD, because a degree of divergence for an infrared laser light flux is too great in recording and reproducing of information for CD, although it has high diffraction efficiency in any wavelength level.

In Example 3 for numerical values of Patent Document 2, there is disclosed an objective lens in which spherical aberration caused by a protective layer thickness difference among a high density optical disc, DVD and CD by providing a diffractive structure that generates third order diffracted light in a violet laser light flux, and generates second order diffracted light in a red laser light flux and an infrared laser light flux on the surface of the objective lens.

In this objective lens, there are problems that it cannot cope with speeding :up of recording and reproducing speed for optical discs because each of diffraction efficiency for third diffracted light of a violet laser light flux and diffraction efficiency for second diffracted light of an infrared laser light flux is as low as 70%, excellent recording and reproducing characteristics are not obtained because an S/N ratio of detection signals in a photo-detector is low, and a life of a laser light source turns out to be short because voltage to be applied on a laser light source results to be high.

Further, since the protective layer thickness of HD is different from the value meeting the standard, it is impossible to conduct recording and reproducing for an optical disc having a protective layer thickness standard of 0.6 mm.

As a reason why spherical aberration caused by a protective layer thickness between a high density disc and CD cannot be corrected by the diffractive structure in the objective lens described in Patent Document 1, or as a reason why diffraction efficiency of the third diffracted light in a violet wavelength area and diffraction efficiency of the second diffracted light in an infrared wavelength area are lowered in the objective lens described in Patent Document 2, there is given a circumstance that spherical aberration correction effect for violet laser light flux and infrared laser light flux of diffracted light generated by the diffractive structure and the diffraction efficiency of the diffracted light are in the trade-off relationship, because a wavelength of the infrared laser light source used for CD is about twice a wavelength of a violet laser light source used for a high density optical disc.

Example 3 for numerical values of Patent Document 2 discloses an example wherein a decline of diffraction efficiency is distributed to a high density disc and to CD, for correcting spherical aberration.

Namely, in the objective lens in Example 7 for numerical value in Patent Document 1 corresponding to an occasion where diffraction efficiency of the diffracted light of a violet laser light flux and diffraction efficiency of the diffracted light of an infrared laser light flux are secured to be high, a diffraction angle of the diffracted light of a violet laser light flux and a diffraction angle of the diffracted light of an infrared laser light flux substantially agree with each other, whereby spherical aberration caused by a protective layer thickness between a high density optical disc and CD cannot be corrected by the diffractive structure.

Incidentally, in addition to the diffractive structure described in Patent Documents 1 and 2, even in the case of a technology employing a phase correcting structure (which is called an optical path difference providing structure in the present specification) described in Patent Document 3, spherical aberration correcting effect by an optical path difference providing structure for the violet laser light flux and the infrared laser light flux and the diffraction efficiency of the optical path difference providing structure are in the trade-off relationship, in the same way as in the diffractive structure.

### SUMMARY OF THE INVENTION

A subject of the invention is to provide an objective optical element which has been achieved in view of the problems stated above, and can converge light emitted from each light source on an optical information recording medium of each of HD, DVD and CD, and an optical pickup apparatus employing the objective optical element.

For solving the aforementioned problems, the structure described in Item 1 is an objective optical element used in an optical pickup apparatus conducting reproducing and/or recording of information by using a light flux emitted from the first light source with wavelength λ1 for the first optical information recording medium with protective base board thickness t1, conducting reproducing and/or recording of information by using a light flux emitted from the second light source with wavelength λ2 (1.5×λ1≦λ2≦1.7×λ1) for the second optical information recording medium with protective base board thickness t2 (0.9×t1≦t2≦1.1×t1), and conducting reproducing and/or recording of information by using a light flux emitted from the third light source with wavelength λ3 (1.8×λ1≦λ3≦2.2×λ1) for the third optical information recording medium with protective base board thickness t3 (0.9×t1≦t3≦2.1×t1), wherein the objective optical element is composed of two or more lenses including a first lens and a second lens, the first lens is made of material A whose Abbe's number is within a range of 20-40 for d-line, and has the first diffractive structure which is constructed by arranging patterns each being staircase-shaped in terms of a cross-sectional form including an optical axis in a form of concentric circles, on at least one optical surface, and the second lens is made of material B whose Abbe's number is within a range of 40-70 for d-line, and has the second diffractive structure which is constructed with plural ring-shaped zones in a form of concentric circles each having a center on an optical axis, and has a cross-sectional form including an optical axis is in a serrated form, on at least one optical surface.

### BRIEF EXPLANATION OF DRAWINGS

FIG. 1 is a top view of primary portions showing the structure of an optical pickup apparatus.

FIG. 2 is a top view of primary portions showing the structure of an objective optical element.

FIG. 3 is a front view showing the structure of the first lens.

FIG. 4 is a top view of primary portions showing the structure of an objective optical element.

### DETAILED DESCRIPTION OF THE PREFERRED EMBODIMENT

Preferred embodiments of the invention will be explained as follows.

The structure of the objective optical element in Item 1 makes it possible to emit a light flux with wavelength λ1 which is in relationship of an integer ratio in terms of wavelength ratio (for example, a violet laser light flux with wavelength λ1 of about 407 nm) and a light flux with wavelength λ3 (for example, an infrared laser light flux with wavelength λ3 of about 785 nm) at different angles, by using the first diffractive structure, which makes spherical aberration correction to be compatible with high diffraction efficiency.

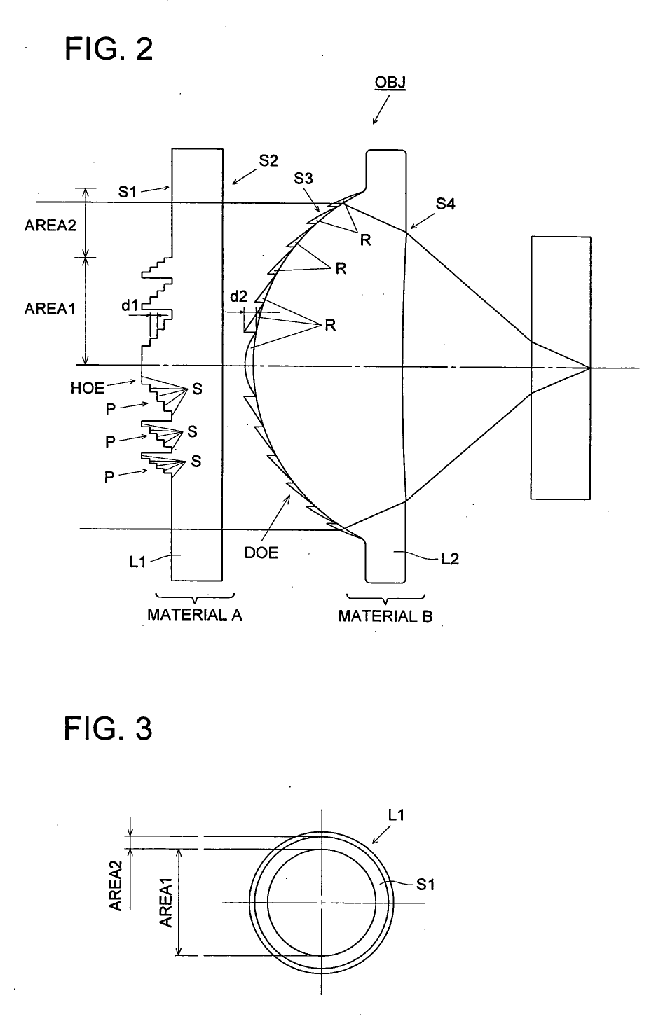

The first diffractive structure (see FIG. 2) is one to be formed on an optical surface of the first lens made of material A whose Abbe's number for d-line is within a range of 20-40, and it is constructed by arranging patterns each being staircase-shaped in terms of a cross-sectional form including an optical axis in a form of concentric circles, and each pattern is constructed by plural steps (three steps in the drawing).

In this case, when the first lens is made of low dispersion material C (Abbe's number for d-line is 40-70) as in the past, if the first diffractive structure is designed so that a light flux with wavelength λ1 may be transmitted, namely, a phase difference may not be given substantially to the passing light flux with wavelength λ1, under the condition that d1 represents a depth in the optical axis direction for each of plural steps constituting each pattern, n_{c407} represents the refractive index for wavelength λ1 (=407 nm) of material A constituting the first lens, n_{c785} represents the refractive index for wavelength λ3 (=785 nm) of material A, and constituting the first lens and the refractive index of a air layer is 1, the following expression (1) holds.
d1 (n_{c407}−1)≈407×N1 (N1 is a natural number)

If a light flux with wavelength λ3 enters the first diffractive structure designed as stated, the following expression (2) holds.
d1 (n_{c785}−1)≈785×N1/2

Compared with a wavelength ratio of incident light flux (407:785≈1:2), a ratio of difference of the refractive index between material C and a air layer (n_{c407}−1)/(n_{c785}−1) is close enough to 1, and therefore, the left side of the expression (1) is substantially the same as the left side of the expression (2), and a value to be multiplied by 785 on the right side of the expression (2) is a half of natural number N1, whereby, when N1 is an even number, a phase difference to be given by each ring-shaped zone of the diffractive structure when light enters becomes to be the same for light with wavelength λ1 and light with wavelength λ2, which means that light is diffracted or is transmitted in the same direction.

In the structure in Item 1, therefore, the first lens is made of high dispersion material A (whose Abbe's number for d-line is 20-40.

As material A, there is given, as an example, amorphous polyester resin “O-PET” (a tradename in Kanebo Co.)

If the first diffractive structure is designed so that a light flux with wavelength λ1 may be transmitted, namely, a phase difference may not be given substantially to the passing light flux with wavelength λ1, under the condition that d1 represents a depth in the optical axis direction for each of plural steps constituting each pattern, n_{A407} represents the refractive index of material A for wavelength λ1 (=407 nm) and n_{A785} represents the refractive index of material A for wavelength λ3 (=785 nm), the following expression (3) holds.
d1 (n_{c407}−1)≈407×N2 (N2 is a natural number)

If a light flux with wavelength λ3 enters the first diffractive structure designed as stated, the following expression (4) holds.
d1 (n_{A785}−1)≈785×N3 (N3 is a natural number)

When the objective lens is constructed as stated above, a ratio (n_{A407}−1)/(n_{A785}−1) of the difference of refractive index between material A and an air layer is far enough from 1 because of a difference in dispersion, compared with a ratio (407:785≈1:2) of wavelength of incident light flux, whereby, the left side of the expression (3) and the left side of the expression (4) are different each other in terms of a value. Therefore, value N3 to be multiplied with 785 on the right side of the expression (4) is not a half of natural number N2, thus, it is possible, as a result, to give a desired difference of diffracted angle for light with wavelength λ1 and light with wavelength λ3 by an width (pitch) per one cycle in the direction perpendicular to the optical axis.

Incidentally, in the present specification, a light flux transmitted through the diffractive structure, namely, a light flux that is not substantially given a phase difference when it passes through the diffractive structure is expressed as “0-order diffracted light”.

When the objective optical element is composed of two or more lenses, working distance WD becomes short, compared with an occasion to construct with a single lens, and in particular, in the case of a thin-type optical pickup apparatus, working distance WD on the third optical information recording medium side is problematic. However, working distance WD for CD is not on the level that makes it impossible to materialize the optical pickup apparatus, because a difference of protective base board thickness between HD and CD is the same as that of protective base board thickness between DVD and CD. However, when wishing to secure sufficient WD for protection of the optical disc, it is possible to secure WD without having an influence on recording on the first optical information recording medium, by giving diffracting actions to the light flux with wavelength λ3 by the use of the first diffractive structure.

Further, by providing the second diffractive structure having a cross-sectional form including an optical axis that is in a serrated form, on the second lens made of low dispersion material B (whose Abbe's number for d-line is 40-70), it is possible to give diffracting actions with the second diffractive structure to the light flux with wavelength λ1 transmitted through the first diffractive structure, and to correct chromatic aberration relating to the first optical information recording medium utilizing the diffracted light or to achieve compatibility with the second optical information recording medium.

Incidentally, it is also possible to obtain a function of compatibility with the second optical information recording medium, by making three or more optical surfaces of the first lens and the second lens to be an aspheric surface without making the second diffractive structure to have a function of compatibility with the second optical information recording medium.

Further, Abbe's number for d-line of material B forming the second lens is within a range 40-70, and this is the Abbe's number of ordinary optical resin. Therefore, processability of the second lens can be improved.

Incidentally, in the present specification, DVD is a generic name of optical discs in DVD series such as DVD-ROM, DVD-Video, DVD-Audio, DVD-RAM, DVD−R, DVD−RW, DVD+R and DVD+RW, and CD is a generic name of optical discs in CD series such as CD-ROM, CD-Audio, CD-Video, CD-R and CD-RW.

In the present specification, “an objective optical element” means an optical system composed of two or more lenses including a light-converging element that is arranged at the position facing an optical information recording medium in an optical pickup apparatus and has a function to converge a light flux emitted from a light source on an information recording surface of the optical information recording medium.

A structure described in Item 2 is the objective optical element described in Item 1, wherein there are provided two lenses including the first lens arranged on the light source side and the second lens arranged on the optical information recording medium side.

When making the objective optical element to be of a two-lens structure including the first lens and the second lens, it is preferable that the first diffractive structure is formed on a plane as far as possible, from the viewpoint of prevention of a decline of an amount of light and of processability. Therefore, it is preferable to arrange the first lens on the light source side and to arrange the second lens having a light-converging function on the optical information recording medium side, as shown in the structure described in Item 2. Owing to this, it is possible to reduce a decline of efficiency that is caused by shades of the first and second diffractive structures.

A structure described in Item 3 is the objective optical element described in Item 1 or Item 2, wherein depth d1 in the optical axis direction of each step that constitutes the pattern of the first diffractive structure satisfies;
0.9×λ1×7/(n1−1)≦d1≦1.1×λ1×7/(n1−1)
wherein, n1 represents a refractive index of the material A for the light flux with wavelength λ1.

By setting the depth d1 in the optical axis direction of each step of the first diffractive structure to be within the aforesaid range, as in the structure described in Item 3, transmittance for light with wavelength λ1 can be enhanced.

A structure described in Item 4 is the objective optical element described in Item 1 or Item 2, wherein Abbe's number of the material A for d-line is within a range of 25-35.

In Item 4, a preferable range of Abbe's number of the material A for d-line can be prescribed.

A structure described in Item 5 is the objective optical element described in Item 1 or Item 2, wherein the number of steps constituting each pattern of the first diffractive structure is 3.

Incidentally, the number of steps means the number of optical surfaces in a form of ring-shaped zones existing in one cycle of diffraction.

The structure described in Item 5 makes it possible to reduce a depth of a ring-shaped zone in the direction that is in parallel with an optical axis, while keeping diffraction efficiency or transmittance for both of light with wavelength λ1 and light with wavelength λ3 to be high.

With respect to a form of each pattern in the first diffractive structure, it is known that an amount of light of a passing light flux is reduced more as a ratio of a length (depth) in the optical axis direction to a length (pitch) in the direction perpendicular to the optical axis direction becomes to be closer to 1:1, and for securing an amount of light, it is preferable to reduce a depth for a pitch, and to maintain a range of the expression shown in Item 5.

A structure described in Item 6 is the objective optical element described in Item 1 or Item 2, wherein a light flux with wavelength λ1 and a light flux with wavelength λ2 are transmitted without being diffracted, and a light flux with wavelength λ3 is diffracted.

The structure described in Item 6 makes it possible to set the direction of diffraction of light completely individually for light with wavelength λ1 and light with wavelength λ3, by giving diffracting actions only to light with wavelength λ3.

A structure described in Item 7 is the objective optical element described in Item 1 or Item 2, wherein the diffracting power of the first diffractive structure is negative.

By making the diffracting power of the first diffractive structure to be negative as in the structure described in Item 7, it is possible to converge a light flux with wavelength λ3 on the information recording surface of the third optical information recording medium under the state where aberration is corrected to the level that causes no practical troubles, by giving, in advance, chromatic aberration with which the excessive amount of correction in the case of passing the second diffractive structure is canceled, to the light flux with wavelength λ3 that solely receives diffracting actions when passing through the first diffractive structure.

A structure described in Item 8 is the objective optical element described in Item 1 or Item 2, wherein the optical surface of the first lens on which the first diffractive structure is formed is a surface having no refracting power for the passing light flux.

A structure described in Item 9 is the objective optical element described in Item 8, wherein another optical surface of the first lens that is different from the surface where the first diffractive structure is formed is a surface having no refracting power or a plane.

In the structure described in Item 8 and Item 9, an optical surface of each ring-shaped zone of the first diffractive structure is perpendicular to the optical axis (same angle to the optical axis), whereby, processability is improved.

Further, in the case of a curved surface, a decline of an amount of light is caused by shades of diffraction for diffracting light, and in the case of a plane, there is not influence of shades, and efficiency is 100% for transmitted light.

A structure described in Item 10 is the objective optical element described in Item 1 or Item 2, wherein distance d2 of the step in the optical axis direction for each ring-shaped zone of the second diffractive structure satisfies the following expression;
λ1×8/(n2−1)≦d2<λ1×12/(n2−1)
wherein, n2 represents a refractive index of the material B for the light flux with wavelength λ1.

By making distance d2 of the step in the second diffractive structure to be within the aforesaid range, the diffraction order number of the diffracted light having the greatest diffraction efficiency among light fluxes with wavelength λ1 passing through the second diffractive structure becomes a high order of 8^{th} order or higher, and therefore, a pitch of the diffractive structure can be broadened, and processability of the second lens can be improved.

A structure described in Item 11 is the objective optical element described in Item 1 or Item 2, wherein Abbe's number of the material B for d-line is within a range of 40-60.

In Item 11, a preferable range of Abbe's number of the material B for d-line can be prescribed.

A structure described in Item 12 is the objective optical element described in any one of Items 1-11, wherein power ratio P/PD of diffracting power P of the second diffractive structure for the light flux with wavelength λ1 to refracting power PD of the second lens for the light flux with wavelength λ1 satisfies the following expression.
1.0×10⁴≦P/PD≦5.0×10⁴

When f represents a focal length in the case of no existence of the second diffractive structure, P=1/f holds. When φ represents an optical path difference function of the second diffractive structure, it is expressed by φ=ΣC₂ᵢh²ⁱ×m×λ/λB, and it is possible to express with PD=1/fD=(−1)×2×C₂×m×λ/λB;

wherein, C₂ᵢ represents a coefficient of an optical path difference function, h (mm) represents a height in the direction perpendicular to the optical axis, m represents the diffraction order number of the diffracted light having the maximum diffraction efficiency among diffracted light of incident light flux, λ(nm) represents a wavelength of the light flux entering the diffractive structure, λB (nm) represents a manufacture wavelength of the diffractive structure and fD represents a focal length by diffraction.

A structure described in Item 13 is the objective optical element described in Item 1, wherein the first lens is arranged on the optical information recording medium side and the second lens is arranged on the light source side.

In the objective optical element composed of plural lenses, a lens arranged to be closer to the optical information recording medium has a greater ratio of effective diameter for each optical information recording medium, namely, an area which is not used for recording and reproducing for the third optical information recording medium but is used for recording and reproducing for other optical information recording media becomes broader. In that area, therefore, an optimum diffractive structure for light with wavelength λ1 and light with wavelength λ2 can be obtained.

A structure described in Item 14 is the objective optical element described in Item 1 or Item 3, wherein the first diffractive structure is formed on an optical surface of the first lens on the light source side.

Compared with an occasion wherein the first diffractive structure is formed on the optical information recording medium side, a pitch turns out to be broader and processability is improved, and an angle of incidence and an angle of emergence for light for the step of a diffractive ring-shaped zone are small, thus, a decline of an amount of light caused by the diffractive structure can be made small.

A structure described in Item 15 is the objective optical element described in any one of Items 1-14, wherein optical system magnifications m1, m2 and m3 of the objective optical element respectively for light with wavelength λ1, light with wavelength λ2 and light with wavelength λ3 satisfy the following expressions.
− 1/100≦m1≦ 1/100
− 1/100≦m2≦ 1/100
− 1/100≦m3≦ 1/100

In the structure described in Item 15, each light flux enters the objective optical element in the form of infinite collimated light for the objective optical element, or in the form of finite light which is close to the collimated light, in the structure, thus, comatic aberration caused in the course of tracking of the objective lens can be reduced.

A structure described in Item 16 is the objective optical element described in any one of Items 1-15, wherein the refractive index of the material B for d-line is within a range of 1.30-1.60.

In Item 16, a preferable range of the refractive index of the material B for d-line is prescribed.

A structure described in Item 17 is the objective optical element described in any one of Items 1-16, wherein the second diffractive structure has a function to correct chromatic aberration for the light flux with wavelength λ1.

A structure described in Item 18 is the objective optical element described in any one of Items 1-17, wherein the diffracting power of the second diffractive structure for the light flux with wavelength λ3 is positive. By making the diffracting power of the second diffractive structure to be positive as in the structure described in Item 18, it is possible to make the second diffractive structure to have a function to correct chromatic aberration.

A structure described in Item 19 is the objective optical element described in any one of Items 1-18, wherein the first diffractive structure is formed only on the area through which light fluxes respectively with wavelengths λ1, λ2 and λ3 used for reproducing and/or recording of information respectively for the first, second and third optical information recording media pass commonly.

In the structure described in Item 19, it is avoided that the first diffractive structure is provided on an unnecessary area and an amount of light is lowered unnecessarily, and it is possible to make the light with wavelength λ3 to have a function to limit an aperture by changing the diffractive structure between the area necessary for recording and reproducing and the area that is not necessary.

A structure described in Item 20 is characterized to be provided with the objective optical element described in any one of Items 1-19.

The invention makes it possible to obtain an objective optical element capable of converging light emitted from each light source on each optical information recording medium for HD, DVD and CD, and to obtain an optical pickup apparatus employing the aforesaid objective optical element.

Preferred embodiments for practicing the invention will be explained in detail as follows, referring to the drawings.

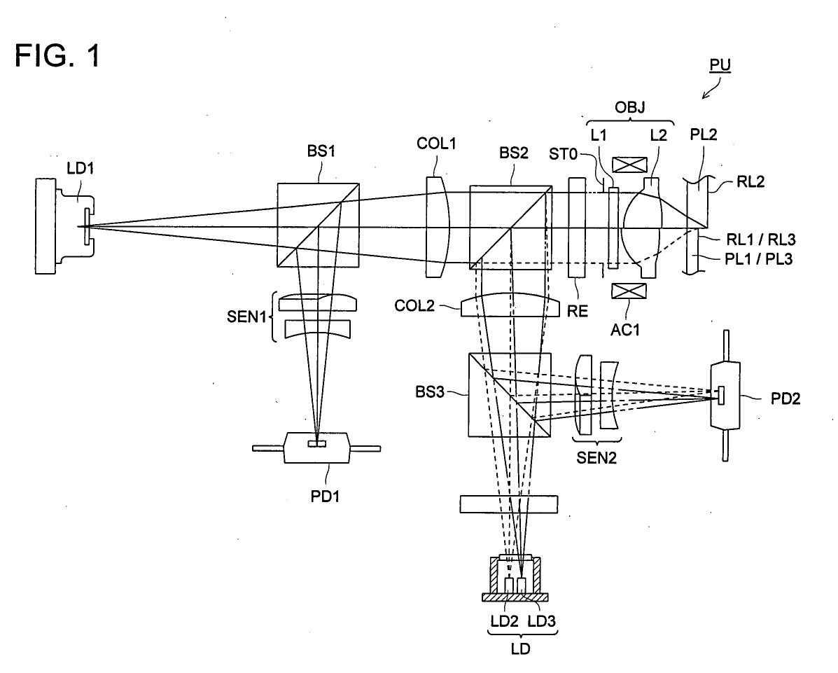

FIG. 1 is a diagram showing schematically the structure of optical pickup apparatus PU capable of conducting recording and reproducing of information properly for any of HD (first optical information recording medium), DVD (second optical information recording medium) and CD (third optical information recording medium). Optical specifications of HD include wavelength λ1=407 nm, thickness t1=0.6 mm for protective layer (protective base board) PL1 and numerical aperture NA1=0.65, optical specifications of DVD include wavelength λ2=655 nm, thickness t2=0.6 mm for protective layer PL2 and numerical aperture NA2=0.65, and optical specifications of CD include wavelength λ3=785 nm, thickness t3=1.2 mm for protective layer PL3 and numerical aperture NA3=0.51.

Further, m1=m2=m3=0 holds for optical system magnifications (m1−m3) in the case of conducting recording and/or reproducing of information for the first—third optical information recording media. Namely, objective optical element OBJ in the present embodiment has the structure wherein all of the first—third light fluxes enter as collimated lights.

However, combination of a wavelength, a thickness of the protective layer, a numerical aperture and an optical system magnification is not limited to the foregoing.

Optical pickup apparatus PU is composed of violet semiconductor laser LD1 (first light source) that is operated to emit light when conducting recording and reproducing of information for HD and emits laser light flux (first light flux) with wavelength of 407 nm, photo-detector PD1 for the first light flux, light source unit LU in-which red semiconductor laser LD2 (second light source) that is operated to emit light when conducting recording and reproducing of information for DVD and emits laser light flux (second light flux) with wavelength of 655 nm and infrared semiconductor laser LD3 (third light source) that is operated to emit light when conducting recording and reproducing of information for CD and emits laser light flux (third light flux) with wavelength of 785 nm are united solidly, photo-detector PD2 for the second and third light fluxes, first collimator lens COL1 through which the first light flux only passes, second collimator lens COL2 through which the second and third light fluxes pass, objective optical element OBJ having therein first lens L1 on which the first diffractive structure is formed on an optical surface and two-sided aspheric surface second lens L2 having the second diffractive structure on its optical surface and having a function to converge a laser light flux transmitted through the first lens L1 on each of information recording surfaces RL1, RL2 and RL3 is formed on an optical surface, first beam splitter BS1, second beam splitter BS2, third beam splitter BS3, aperture STO, and sensor lenses SEN1 and SEN2.

In the optical pickup apparatus PU, when conducting recording and reproducing of information for HD, the violet semiconductor laser LD1 is first operated to emit light, as its light path is shown with solid lines in FIG. 1. A divergent light flux emitted from the violet semiconductor laser LD1 passes through the first beam splitter BS1 to arrive at the first collimator lens COL1.

When the first light flux is transmitted through the first collimator lens COL1, it is converted into a collimated light which passes through the second beam splitter BS2 and ¼ wavelength plate RE to arrive at objective optical element OBJ, and becomes a spot that is formed by the objective optical element OBJ on information recording surface RL1 through first protective layer PL1. The objective optical element OBJ is subjected to focusing and tracking conducted by biaxial actuator AC1 arranged around the objective optical element.

A reflected light flux modulated by information pits on information recording surface RL1 passes again through the objective optical element OBJ, ¼ wavelength plate RE, the second beam splitter BS2 and the first collimator lens COL1, then, is branched by the first beam splitter BS1, and is given astigmatism by sensor lens SEN1 to be converged on a light-receiving surface of photo-detector PD1. Thus, information recorded on HD can be read by the use of output signals of the photo-detector PD1.

When conducting recording and reproducing of information for DVD, the red semiconductor laser LD2 is first operated to emit light, as its light path is shown with dotted lines in FIG. 1. A divergent light flux emitted from the red semiconductor laser LD2 passes through the third beam splitter BS3 to arrive at the second collimator lens COL2.

When the light flux is transmitted through the second collimator lens COL2, it is converted into a collimated light which is reflected by the second beam splitter BS2, then, it passes through ¼ wavelength plate RE to arrive at objective optical element OBJ, and becomes a spot that is formed by the objective optical element OBJ on information recording surface RL2 through second protective layer PL2. The objective optical element OBJ is subjected to focusing and tracking conducted by biaxial actuator AC1 arranged around the objective optical element.

A reflected light flux modulated by information pits on information recording surface RL2 passes through ¼ wavelength plate RE, and is reflected on the second beam splitter BS2, and then, passes through collimator lens COL2 to be branched by the third beam splitter BS3, and is converged on a light-receiving surface of photo-detector PD2. Thus, information recorded on DVD can be read by the use of output signals of the photo-detector PD2.

When conducting recording and reproducing of information for CD, the infrared semiconductor laser LD3 is first operated to emit light, as its light path is shown with two-dot chain lines in FIG. 1. A divergent light flux emitted from the infrared semiconductor laser LD3 passes through the third beam splitter BS3 to arrive at the second collimator lens COL2.

When the light flux is transmitted through the second collimator lens COL2, it is converted into a gently collimated light flux which is reflected by the second beam splitter BS2, then, it passes through ¼ wavelength plate RE to arrive at objective optical element OBJ, and becomes a spot that is formed by the objective optical element OBJ on information recording surface RL3 through third protective layer PL3. The objective optical element OBJ is subjected to focusing and tracking conducted by biaxial actuator AC1 arranged around the objective optical element.

A reflected light flux modulated by information pits on information recording surface RL3 passes again through objective optical element OBJ and ¼ wavelength plate RE, and is reflected on the second beam splitter BS2, and then, passes through collimator lens COL2 to be branched by the third beam splitter BS3, and is converged on a light-receiving surface of photo-detector PD2. Thus, information recorded on CD can be read by the use of output signals of the photo-detector PD2.

Next, the structure of the objective optical element OBJ will be explained.

As shown schematically in FIG. 2, the objective optical element is a plastic lens wherein the first lens L1 and the second lens L2 are united solidly on the same axis through a lens frame (not shown).

The first lens is made of material A having Abbe's number within a range of 20-40 for d-line, and each of plane of incidence S1 (optical surface on the light source side) and plane of emergence S2 (optical surface on the optical information recording medium side) of the first lens is composed of a plane having no refracting power for a passing light flux.

Further, as shown in FIGS. 2 and 3, plane of incidence S1 of the first lens L1 is divided into first area AREA1 including an optical axis corresponding to an area in NA3 and second area AREA2 corresponding to an area from NA3 to NA1, and on the first area, there is formed first diffractive structure HOE that is constituted by arranging patterns P each having a staircase-shaped section including an optical axis in a form of concentric circles.

The second lens L2 is made of material B having Abbe's number within a range of 40-70 for d-line, and each of plane of incidence S3 (optical surface on the light source side) and plane of emergence S4 (optical surface on the optical information recording medium side) of the second lens L2 is composed of an aspheric surface.

Further, on the total area within an effective diameter of the plane of incidence S3 of the second lens L2, there is formed the second diffractive structure DOE that is constituted with plural ring-shaped zones R in a form of concentric circles each having its center on the optical axis, and has a section including the optical axis that is in a form of serration.

In the first diffractive structure HOE formed on the first area AREA1, depth d1 in the optical axis direction of each step S constituting each pattern P is established to satisfy the following expression;
0.9×λ1×7/(n1−1)≦d1<1.1×λ1×7/(n1−1)
wherein, n1 represents a refractive index of material A for a light flux with wavelength λ1.

Owing to circumstances where depth d1 in the optical axis direction is established as in the foregoing, the light flux with wavelength λ1 and the light flux with wavelength λ2 are transmitted through the first diffractive structure HOE without being given a phase difference substantially. Further, the light flux with wavelength λ3 is substantially given a phase difference and receives diffracting actions in the first diffractive structure HOE, because Abbe's number (20-40) of the material A is small when comparing with Abbe's number (40-70) of general materials, namely, because dispersion of the material A is great compared with general materials, and the refractive index of the material A for the light flux with wavelength λ1 is greatly different from the refractive index of the material A for the light flux with wavelength λ3.

In-specific explanation, depth d1 between adjacent ring-shaped zones (steps) is established to d1=0.407×7/(1.648146−1.0)≈4.40 (μm), in the first diffractive structure HOE. Therefore, when light with wavelength λ1=0.407 (μm) enters this diffractive structure, an optical path difference of 2π×3 is generated, and a phase difference is not caused substantially. Namely, light can be transmitted at high efficiency (100%).

When light with wavelength λ2=0.655 (μm) enters the first diffractive structure HOE, an optical path difference of 2π×d1×(1.592675−1.0)/0.655≈2π×3.98 is generated by adjacent ring-shaped zones, and a substantial phase difference is not present, thus, the light is transmitted at high diffraction efficiency (99%).

When light with wavelength λ3=0.785 (μm) enters the first destructive structure HOE, an optical path difference of d1×(1.583833−1.0)/0.785=290 ×3.27 is generated, but, if the structure with three steps in one cycle is employed, 2π×3.27×3=2π×9.81 holds to be close to a value of an integer, and light is diffracted at high diffraction efficiency (61%).

Further, distance d2 between steps in the optical axis direction of each ring-shaped zone R in the second diffractive structure DOE is established to satisfy the following expression;
λ1×8/(n2−1)≦d2<λ1×12/(n2−1)

wherein, n2 represents a refractive index of material B for a light flux with wavelength λ1.

Further, diffracting power of the first diffracting structure is established to be negative, while, diffracting power of the second diffracting structure for a light flux with wavelength λ3 is established to be positive.

Under the condition that neither the first diffractive structure nor the second diffractive structure is formed on an objective lens, chromatic aberrations are generated by light fluxes respectively with wavelengths λ1, λ2 and λ3 emitted from respective light sources, and an amount of generation of the chromatic aberration is most for HD, and it is diminished in the order of DVD and CD.

Accordingly, when the second diffractive structure DOE is designed so that chromatic aberration of HD may be 0 substantially, namely, when the second diffractive structure DOE is made to have a function to correct chromatic aberration for light flux with wavelength λ1, there is caused an inconvenience that chromatic aberration is corrected excessively for light fluxes with wavelengths λ2 and λ3 that pass through the second diffractive structure DOE, and an amount of excessive correction of chromatic aberration for CD in this case is greater than that for DVD.

Therefore, by making the diffracting power of the first diffractive structure HOE to be negative as stated above, it is possible to give, in advance, chromatic aberration for which an excessive correction amount can be canceled to the light flux with wavelength λ3 receiving solely diffracting actions, when passing through the first diffractive structure HOE, and thereby, to converge a light flux with wavelength λ3 on information recording surface RL3 of CD, as a result, under the condition that aberration is corrected to the level that causes no troubles on practical use.

In this case, chromatic aberration still remains for the light flux with wavelength λ2 for DVD, but, an amount thereof is small, and no troubles are caused for reproducing and recording for DVD.

Incidentally, when the first optical information recording medium (HD) is the same as the second optical information recording medium (DVD) in terms of a thickness of a protective base board (t1=t2) as in the present embodiment, spherical aberration of color caused by a difference between wavelength λ1 and wavelength λ2 can be corrected by making at least one optical surface of the objective optical element OBJ to be a refracting interface. When correcting with the refracting interface, at least three aspheric surfaces of the objective optical element OBJ are needed. When correcting spherical aberration of color with a diffraction surface, it is possible to make-the diffraction surface to have a function to correct chromatic aberration coping with mode-hop of the first optical information recording medium.

In the optical pickup apparatus PU shown in the present embodiment, objective optical element OBJ is composed of the first lens L1 and the second lens L2 as stated above, and the first lens L1 among these lenses is made of material A whose Abbe's number for d-line is within a range of 20-40 and the first diffractive structure HOE is formed on the first lens L1, while, the second lens L2 is made of material B whose Abbe's number for d-line is within a range of 40-70 and the second diffractive structure DOE is formed on the second lens L2.

Owing to the foregoing, it is possible to make a light flux with wavelength λ1 (for example, violet laser light flux with wavelength λ1 that is about 407 nm) and a light flux with wavelength λ3 (for example, infrared laser light flux with wavelength λ2 that is about 785 nm) which are in relationship where the ratio of wavelength is substantially a ratio of an integer, to emerge at different angles each other by the use of the first diffracting structure HOE, and thereby to correct spherical aberration, for example, and to secure transmittance.

Incidentally, though light source unit LU wherein red semiconductor laser LD3 and infrared semiconductor laser LD2 are united solidly is used in the present embodiment, it is also possible to use a laser light source unit for HD, DVD and CD in which violet semiconductor laser LD1 (first light source) is also contained in the same casing, without being limited to the foregoing.

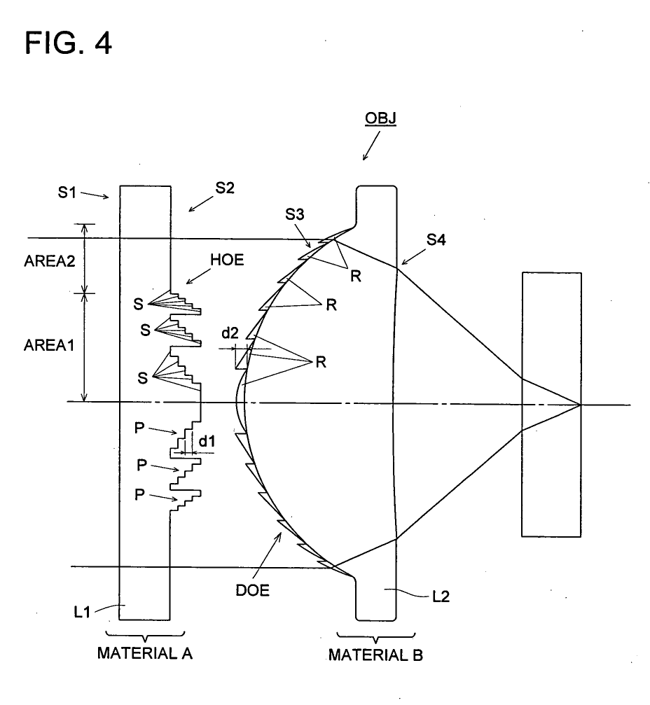

Further, though the first lens L1 is arranged on the light source side and the second lens L2 is arranged on the optical information recording medium side, and the first diffractive structure HOE is formed on plane of incidence S1 of the first lens L1 and the second diffractive structure DOE is formed on plane of incidence S3 of the second lens L2 in the present embodiment, the relative position between the first lens L1 and the second lens L2 and positions of optical surfaces where the first diffractive structure HOE and the second diffractive structure DOE are formed can be varied properly, without being limited to the foregoing, such as the case where the first diffractive structure HOE is formed on the plane of emergence S2 of the first lens L1 (Examples 1 and 2) under the condition that the first lens L1 is arranged on the light source side and the second lens L2 is arranged on the optical information recording medium side as shown in FIG. 4, or the first diffractive structure is formed on the plane of incidence of the first lens L1 (Example 3) under the condition that the second lens L2 is arranged on the light source side and the first lens L1 is arranged on the optical information recording medium side.

### EXAMPLE

Next, Examples of the objective optical element shown in the above embodiment will be explained.

Table 1 shows lens data of Example 1.

TABLE 1
Example 1 Lens Data

| | | | |
|---|---|---|---|
| Focal length of | f₁ = 2.6 mm | f₂ = 2.68 mm | f₃ = 2.85 mm |
| objective lens | | | |
| Numerical aperture | NA1: 0.67 | NA2: 0.65 | NA3: 0.51 |
| on image side | | | |
| Magnification | m1: 0 | m2: 0 | m3: 0 |

| i^{th} | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| *1 | | (φ3.484 mm) | | (φ3.484 mm) | | (φ3.484 mm) | |
| 2 | ∞ | 0.80 | 1.648146 | 0.80 | 1.592675 | 0.80 | 1.583833 |
| 3 | ∞ | 0.05 | 1.0 | 0.05 | 1.0 | 0.05 | 1.0 |
| 3′ | ∞ | 0.00 | 1.0 | 0.00 | 1.0 | 0.00 | 1.0 |
| 4 | 1.48713 | 1.80 | 1.46236 | 1.80 | 1.447749 | 1.80 | 1.444785 |
| 5 | −4.00393 | 1.22 | 1.0 | 1.29 | 1.0 | 1.10 | 1.0 |
| 6 | ∞ | 0.6 | 1.61869 | 0.6 | 1.57752 | 1.2 | 1.57063 |
| 7 | ∞ | | | | | | |

*1: (Aperture diameter)
* 3′ shows a displacement from 3′^{th} surface to 3^{rd} surface.

3^{rd} surface (0 mm ≦ h ≦ 1.453 mm)
Optical path difference function
(Manufacture wavelength 785 nm)

| | |
|---|---|
| Diffraction order number | 0/0/1 |
| Diffraction efficiency | 100/99/61 |
| (scalar calculation) | |
| C2 | 1.1875E−02 |
| C4 | −1.3192E−04 |
| C6 | −1.7020E−05 |

3′^{th} surface
(1.453 mm ≦ h)
4^{th} surface
Aspheric surface coefficient

| | |
|---|---|
| κ | −1.0290E+00 |
| A4 | 1.3316E−02 |
| A6 | −1.1616E−03 |
| A8 | 1.5967E−03 |
| A10 | −6.9686E−04 |
| A12 | 1.8558E−04 |
| A14 | −2.1804E−05 |

Optical path difference function
(Manufacture wavelength 407 nm)

| | |
|---|---|
| Diffraction order number | 8/5/4 |
| Diffraction efficiency | 100/89/100 |
| (scalar calculation) | |
| C2 | −1.7650E−04 |
| C4 | −4.8126E−04 |
| C6 | −6.6199E−05 |
| C8 | 4.8642E−06 |
| C10 | −2.5450E−06 |

5^{th} surface
Aspheric surface coefficient

| | |
|---|---|
| κ | −3.1930E+01 |
| A4 | 5.4571E−03 |
| A6 | 8.4086E−03 |
| A8 | −7.3148E−03 |
| A10 | 3.0470E−03 |
| A12 | −6.8301E−04 |
| A14 | 6.3938E−05 |

| | nd | νd |
|---|---|---|
| Material A | 1.6 | 23 |
| Material B | 1.45 | 60 |

As shown in Table 1, the objective optical element of the present example is one to be used compatibly for HD, DVD and CD, wherein there are established focal length f1=2.6 mm and magnification m1=0 both for wavelength λ1=407 nm, focal length f2=2.68 mm and magnification m2=0 both for wavelength λ2=655 nm and focal length f3=2.85 mm and magnification m3=0 both for wavelength λ3=785 nm.

There are further established refractive index nd for d-line=1.60 and Abbe's number vd for d-line=23 both for material A forming the first lens, and refractive index nd for d-line=1.45 and Abbe's number vd for d-line=60 both for material B forming the second lens.

A plane of emergence of the first lens is divided into a third surface where a height from the optical axis satisfies 0 mm≧h≧1.453 mm and 3′^{th} surface where a height from the optical axis satisfies 1.453 mm<h.

Further, each of the plane of incidence (second surface), 3^{rd} surface and 3′^{th} surface of the first lens is a plane having no refracting power for a passing light flux, and a plane of incidence (fourth surface) and a plane of emergence (5^{th} surface) of the second lens are formed to be aspheric surfaces which are prescribed by the numerical expression wherein a coefficient shown in Table 1 is substituted in the following expression (Numeral 1), and are axially symmetrical about optical axis L.

$$Form expression for aspheric surface \\ X ( h ) = \frac{( {h}^{2} / R )}{1 + \sqrt{1 - ( 1 + κ ) {( h / R )}^{2}}} + {\sum }_{i = 0}^{0} {A}_{2 i} {h}^{2 i} \qquad ( Numeral 1 )$$

In the expression above, x represents an axis in the direction of the optical axis (traveling direction of light is assumed to be positive), κ, represents a conic constant and A₂ᵢ represents an aspheric surface coefficient.

Further, first diffractive structure HOE is formed on the third surface and second diffractive structure DOE is formed on the fourth surface. Each of the first diffractive structure HOE and the second diffractive structure DOE is expressed by an optical path difference to be added by this structure to the transmitted wavefront. The optical path difference of this kind is expressed by optical path difference function φ (h) (mm) defined by substituting a coefficient shown in Table 1 in the following expression (Numeral 2).

$$Optical path difference function \\ Φ ( h ) = {\sum }_{i = 0}^{5} {C}_{2 i} {h}^{2 i} \times m \times λ / λ B \qquad ( Numeral 2 )$$

Manufacture wavelength λB of the first diffractive structure HOE is 785 nm, and manufacture wavelength λB of the second diffractive structure DOE is 407 nm.

Incidentally, “a manufacture wavelength” is a numerical value that defines a differactive structure, and it is a structure wherein scalar diffraction efficiency for light having that wavelength is 100%.

Table 2 shows lens data of Example 2.

TABLE 2
Example 2 Lens Data

| | | | |
|---|---|---|---|
| Focal length of | f₁ = 2.6 mm | f₂ = 2.71 mm | f₃ = 2.85 mm |
| objective lens | | | |
| Numerical aperture | NA1: 0.67 | NA2: 0.65 | NA3: 0.51 |
| on image side | | | |
| Magnification | m1: 0 | m2: 0 | m3: 0 |

| i^{th} | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| *1 | | (φ3.484 mm) | | (φ3.484 mm) | | (φ3.484 mm) | |
| 2 | ∞ | 0.80 | 1.648146 | 0.80 | 1.592675 | 0.80 | 1.583833 |
| 3 | ∞ | 0.05 | 1.0 | 0.05 | 1.0 | 0.05 | 1.0 |
| 3′ | ∞ | 0.00 | 1.0 | 0.00 | 1.0 | 0.00 | 1.0 |
| 4 | 1.65402 | 1.80 | 1.46236 | 1.80 | 1.447749 | 1.80 | 1.444785 |
| 5 | −4.06962 | 1.22 | 1.0 | 1.32 | 1.0 | 1.10 | 1.0 |
| 6 | ∞ | 0.6 | 1.61869 | 0.6 | 1.57752 | 1.2 | 1.57063 |
| 7 | ∞ | | | | | | |

*1: (Aperture diameter)
* 3′ shows a displacement from 3′^{th} surface to 3^{rd} surface.

3^{rd} surface (0 mm ≦ h < 1.454 mm)
Optical path difference function
(Manufacture wavelength 785 nm)

| | |
|---|---|
| Diffraction order number | 0/0/1 |
| Diffraction efficiency | 100/99/61 |
| (scalar calculation) | |
| C2 | 1.2118E−02 |
| C4 | −3.0825E−05 |
| C6 | −4.3627E−05 |

3′^{th} surface
(1.454 mm ≦ h)
4^{th} surface
Aspheric surface coefficient

| | |
|---|---|
| κ | −9.5235E−01 |
| A4 | 1.7972E−02 |
| A6 | −1.9456E−03 |
| A8 | 2.1384E−03 |
| A10 | −6.4562E−04 |
| A12 | 1.2890E−04 |
| A14 | −6.0352E−06 |

Optical path difference function
(Manufacture wavelength 407 nm)

| | |
|---|---|
| Diffraction order number | 2/1/1 |
| Diffraction efficiency | 100/87/100 |
| (scalar calculation) | |
| C2 | −8.8812E−03 |
| C4 | 4.4445E−04 |
| C6 | −3.7902E−04 |
| C8 | 1.7150E−04 |
| C10 | −2.2793E−05 |

5^{th} surface
Aspheric surface coefficient

| | |
|---|---|
| κ | −3.3767E+01 |
| A4 | −2.5002E−03 |
| A6 | 9.2995E−03 |
| A8 | −7.1949E−03 |
| A10 | 3.3800E−03 |
| A12 | −8.3209E−04 |
| A14 | 8.1591E−05 |

| | nd | νd |
|---|---|---|
| Material A | 1.6 | 23 |
| Material B | 1.45 | 60 |

As shown in Table 1, the objective optical element of the present example is one to be used compatibly for HD, DVD and CD, wherein there are established focal length f1=2.6 mm and magnification m1=0 both for wavelength λ1=407 nm, focal length f2=2.71 mm and magnification m2=0 both for wavelength λ2=655 nm and focal length f3=2.85 mm and magnification m3=0 both for wavelength λ3=785 nm.

There are further established refractive index nd for d-line=1.60 and Abbe's number vd for d-line=23 both for material A forming the first lens, and refractive index nd for d-line=1.45 and Abbe's number vd for d-line=60 both for material B forming the second lens.

A plane of emergence of the first lens is divided into a third surface where a height from the optical axis satisfies 0 mm≦h≦1.454 mm and 3′^{th} surface where a height from the optical axis satisfies 1.454 mm≦h.

Further, each of the plane of incidence (second surface), 3^{rd} surface and 3′^{th} surface of the first lens is a plane having no refracting power for a passing light flux, and a plane of incidence (fourth surface) and a plane of emergence (5^{th} surface) of the second lens are formed to be aspheric surfaces which are axially symmetrical about optical axis L.

Further, the first diffractive structure HOE is formed on the third surface and the second diffractive structure DOE is formed on the fourth surface.

Incidentally, manufacture wavelength λB of the first diffractive structure HOE is 785 nm and manufacture wavelength λB of the second diffractive structure DOE is 407 nm.

Table 3 shows lens data of Example 3.

TABLE 3
Example 3 Lens Data

| | | | |
|---|---|---|---|
| Focal length of | f₁ = 2.6 mm | f₂ = 2.90 mm | f₃ = 3.23 mm |
| objective lens | | | |
| Numerical aperture | NA1: 0.65 | NA2: 0.65 | NA3: 0.51 |
| on image side | | | |
| Magnification | m1: 0 | m2: 0 | m3: 0 |

| i^{th} | | di | ni | di | ni | di | ni |
|---|---|---|---|---|---|---|---|
| surface | Ri | (407 nm) | (407 nm) | (655 nm) | (655 nm) | (785 nm) | (785 nm) |
| 0 | | ∞ | | ∞ | | ∞ | |
| 1 | | 0.0 | | 0.0 | | 0.0 | |
| *1 | | (φ3.38 mm) | | (φ3.796 mm) | | (φ3.796 mm) | |
| 2 | 12.582 | 0.80 | 1.6424 | 0.80 | 1.4477 | 0.80 | 1.4448 |
| 3 | −183.70 | 0.05 | 1.0 | 0.05 | 1.0 | 0.05 | 1.0 |
| 4 | 1.9645 | 1.80 | 1.6481 | 1.80 | 1.5927 | 1.80 | 1.5838 |
| 4′ | 1.9645 | 0.00 | 1.6481 | 0.00 | 1.5927 | 0.00 | 1.5838 |
| 5 | 8.2195 | 0.96 | 1.0 | 1.19 | 1.0 | 1.10 | 1.0 |
| 6 | ∞ | 0.6 | 1.6187 | 0.6 | 1.5775 | 1.2 | 1.5706 |
| 7 | ∞ | | | | | | |

*1: (Aperture diameter)
* 4′ shows a displacement from 4′th surface to 4th surface.

2^{nd} surface
Aspheric surface coefficient

| | |
|---|---|
| κ | 2.3949E+01 |
| A4 | 5.3035E−03 |
| A6 | −1.9115E−03 |
| A8 | −1.0239E−03 |
| A10 | 1.9788E−04 |

3^{rd} surface
Aspheric surface coefficient

| | |
|---|---|
| κ | −3.3002E−08 |
| A4 | 1.8538E−04 |
| A6 | −5.6085E−05 |
| A8 | −6.2891E−05 |
| A10 | −5.1919E−05 |

Optical path difference function
(HD DVD: 2^{nd} order, DVD: First order,
CD: First order, Manufacture wavelength 407 nm)

| | |
|---|---|
| C2 | −1.6347E−02 |
| C4 | −4.2287E−03 |
| C6 | 1.2558E−03 |

4^{th} surface (0 mm ≦ h ≦ 1.553 mm)
Aspheric surface coefficient

| | |
|---|---|
| κ | −1.9990E+00 |
| A4 | 4.4100E−03 |
| A6 | 1.8654E−03 |
| A8 | −2.3160E−03 |
| A10 | 3.6435E−03 |
| A12 | −1.2450E−03 |
| A14 | 1.5433E−04 |

Optical path difference function
(HD DVD: 0^{th} order, CD: First order,
Manufacture wavelength 785 nm)

| | |
|---|---|
| C2 | 1.9961E−02 |
| C4 | 3.5356E−03 |
| C6 | 2.2665E−04 |
| C8 | −7.9860E−04 |
| C10 | 1.3930E−04 |

4′^{th} surface (1.553 mm < h)
Aspheric surface coefficient

| | |
|---|---|
| κ | 1.9990E+00 |
| A4 | 4.4100E−03 |
| A6 | 1.8654E−03 |
| A8 | −2.3160E−03 |
| A10 | 3.6435E−03 |
| A12 | −1.2450E−03 |
| A14 | 1.5433E−04 |

5^{th} surface
Aspheric surface coefficient

| | |
|---|---|
| κ | −2.9765E+02 |
| A4 | −1.1854E−02 |
| A6 | −6.0889E−02 |
| A8 | 1.2411E−01 |
| A10 | −9.7714E−02 |
| A12 | 4.0246E−02 |
| A14 | −6.7040E−03 |

| | nd | νd |
|---|---|---|
| Material A | 1.6 | 23 |
| Material B | 1.45 | 60 |

As shown in Table 3, the objective optical element of the present example is one to be used compatibly for HD, DVD and CD, wherein there are established focal length f1=2.6 mm and magnification m1=0 both for wavelength λ=407 nm, focal length f2=2.90 mm and magnification m2=0 both for wavelength λ2=655 nm and focal length f3=3.23 mm and magnification m3=0 both for wavelength λ3=785 nm.

There are further established refractive index nd for d-line=1.60 and Abbe's number vd for d-line=23 both for material A forming the first lens, and refractive index nd for d-line=1.45 and Abbe's number vd for d-line=60 both for material B forming the second lens.

A plane of incidence of the first lens is divided into a fourth surface where a height from the optical axis satisfies 0 mm≦h≦1.553 mm and 4′^{th} surface where a height from the optical axis satisfies 1.553 mm<h.

Further, a plane of incidence (second surface), a plane of emergence (3^{rd} surface), a fourth surface, a 4′^{th} surface and a 5^{th} surface are formed to be aspheric surfaces which are axially symmetrical about optical axis L.

Further, the second diffractive structure DOE is formed on the 3^{rd} surface and the first diffractive structure HOE is formed on the 4^{th} surface.

Incidentally, manufacture wavelength λB of the first diffractive structure HOE is 785 nm and manufacture wavelength λB of the second diffractive structure DOE is 407 nm.

What is claimed is:

1. An objective optical element for use in an optical pickup apparatus which conducts reproducing and/or recording information for a first optical information recording medium having a protective substrate thickness t1 by using a light flux having a wavelength λ1 emitted from a first light source, conducts reproducing and/or recording information for a second optical information recording medium having a protective substrate thickness t2 (0.9×t1≦t2≦1.1×t1) by using a light flux having a wavelength λ2 (1.5×λ1≦λ2≦1.7×λ1) emitted from a second light source, and conducts reproducing and/or recording information for a third optical information recording medium having a protective substrate thickness t3 (1.9×t1≦t3≦2.1×t1) by using a light flux having a wavelength λ3 (1.8×λ1≦λ3≦2.2×λ1) emitted from a third light source, the objective optical element comprising:
at least two lenses of a first lens and a second lens,
wherein the first lens is made of a material A having Abbe's number being within a range of 20 to 40 for d-line and comprises a first diffractive structure in which concentric circle patterns are arranged around an optical axis on at least one optical surface of the first lens and a cross-sectional form of each of the concentric circle patterns is shaped in a stair form, and
the second lens is made of a material B having Abbe's number being within a range of 40 to 70 for d-line and comprises a second diffractive structure in which plural concentric ring-shaped zones are arranged around an optical axis on at least one optical surface of the second lens and a cross-sectional form of each of the plural concentric ring-shaped zones is shaped in a saw tooth form.

2. The objective optical element of claim 1, wherein the objective optical element consists of the first lens arranged at a light source side and the second lens arranged at an optical information recording medium side.

3. The objective optical element of claim 1, wherein the first diffractive structure comprises step sections constructing the concentric circle patterns and each of the step sections has a depth d1 in the optical axis direction which satisfies the following formula:
0.9×λ1×7/(n1−1)≦d1≦1.1×λ1×7/(n1−1)
where n1 represents a refractive index of the material A for the light flux with wavelength λ1.

4. The objective optical element of claim 1, wherein Abbe's number of the material A for d-line is within a range of 25 to 35.

5. The objective optical element of claim 1, wherein the number of the step sections constructing the concentric circle patterns is 3, where the number of step sections is the number of ring-shaped optical surfaces existing in one cycle of diffraction.

6. The objective optical element of claim 1, wherein a light flux having a wavelength λ1 and a light flux having a wavelength λ2 which enter into the first diffractive structure are transmitted without being diffracted, and a light flux with wavelength λ3 which enters into the first diffractive structure is diffracted.

7. The objective optical element of claim 1, wherein the first diffractive structure has a negative diffractive power.

8. The objective optical element of claim 1, wherein an optical surface of the first lens on which the first diffractive structure is formed is a surface having no refractive power for a light flux passing through the surface.

9. The objective optical element of claim 1, wherein another optical surface of the first lens different from an optical surface on which the first diffractive structure is formed is a surface having no refractive power or a flat surface.

10. The objective optical element of claim 1, wherein the second diffractive structure comprises step sections constructing the ring-shaped zones and each of the step sections has a length d2 in the optical axis direction which satisfies the following formula:
λ1×8/(n2−1)≦d2≦λ1×12/(n2−1)
where n2 represents a refractive index of the material B for the light flux with wavelength λ1.

11. The objective optical element of claim 1, wherein Abbe's number of the material B for d-line is within a range of 40 to 60.

12. The objective optical element of claim 1, wherein a power ratio of P/PD satisfies the following formula:
1.0×10⁴≦P/PD≦5.0×10⁴
where P represents a diffracting power of the second diffractive structure for the light flux with wavelength λ1 and PD represents a refracting power of the second lens for the light flux with wavelength λ1.

13. The objective optical element of claim 1, wherein the first lens is arranged at an optical information recording medium side and the second lens is arranged at a light source side.

14. The objective optical element of claim 1, wherein the first diffractive structure is formed on a light source-side optical surface of the first lens.

15. The objective optical element of claim 1, wherein the objective optical element has an optical system magnification m1 for a light flux having a wave length λ1, an optical system magnification m2 for a light flux having a wave length λ2, and an optical system magnification m3 for a light flux having a wave length λ3, and the magnifications λ1, λ2 and λ3 satisfy the following formulas:
− 1/100≦m1≦ 1/100
− 1/100≦m2≦ 1/100
− 1/100≦m3≦ 1/100

16. The objective optical element of claim 1, wherein the refractive index of the material B for d-line is within a range of 1.30 to 1.60.

17. The objective optical element of claim 1, wherein the second diffractive structure has a chromatic aberration correcting function for a light flux having a wavelength λ1.

18. The objective optical element of claim 1, wherein the second diffractive structure has a positive diffractive power for a light flux having a wavelength λ3.

19. The objective optical element of claim 1, wherein the first diffractive structure is formed only on a common region throught which a light flux having a wavelength λ1, a light flux having a wavelength λ2, and a light flux having a wavelength λ3 passes to be used for reproducing and/or recording information for a first, second and third information recording mediums.

20. An optical pickup apparatus provided with the objective optical element described in claim 1.
